(19) United States
(12) Patent Application Publication
(10) Pub. No.: US 2007/0032360 A1
(43) Pub. Date: Feb. 8, 2007

(54) Apparatus for manufacturing and/or treating a material web

(76) Inventor: Diethelm Beisiegel, Gerstetten (DE)

Correspondence Address: TAYLOR & AUST, P.C., 142 SOUTH MAIN STREET, P. O. BOX 560, AVILLA, IN, 46710, US

(21) Appl. No.: 11/498,006

(22) Filed: Aug. 2, 2006

(30) Foreign Application Priority Data
Aug. 5, 2005 (DE) 10 2005 037 646.0

(51) Int. Cl. F16C 13/00

(52) U.S. Cl. 492/15

(57) ABSTRACT

An apparatus for manufacturing and/or treating a fiber material web, in particular a paper or board web, having a roll with a bearing journal which is present at one roll end, a frame for mounting the roll rotatably and a hollow-shaft motor which is plugged onto the bearing journal of the roll, the motor being connected to the roll frame via a motor fastener. The invention also relates to a method for connecting a hollow-shaft drive motor to a roll or for changing or retrofitting the drive of the roll of a machine for manufacturing and/or treating a material web, in particular a paper or board web.

### BACKGROUND OF THE INVENTION

1. Field of the Invention.

The present invention relates to an apparatus for manufacturing and/or treating a material web, in particular a paper or board web, having a roll with a bearing journal which is present at one roll end, a frame for mounting the roll rotatably and a hollow-shaft motor.

2. Description of the Related Art.

Hollow-shaft motors are distinguished by their compactness. They are arranged in such a way that the bearing journal bears substantially the total weight. As a result, the use of motors of this type is restricted, however, with regard to the motor power output, as the comparatively thin bearing journals cannot bear the weight of relatively large motors in a long-lasting manner. Even if there is a relatively thick bearing journal, the problem exists that the arrangement is too unstable if relatively heavy motors are used and the arrangement tends to vibrate.

### SUMMARY OF THE INVENTION

The invention is directed to a motor that is connected to the roll frame via a motor fastening device.

The weight of the motor is transmitted to the roll frame as a result of the use of a motor fastener, via which the motor is connected to the roll frame. Plug-on motors having a relatively high power output can therefore be used in conjunction with the rolls which are mentioned above, without the described problems occurring.

A vibrationally stable fastener is preferably used for the plug-on motor. As a result, the problem of vibrations which occurs in the case of heavy motors can also be solved.

One advantageous development of the invention results if the hollow shaft of the motor is connected to the bearing journal of the roll via a coupling. Plug-on motors according to the invention can therefore also be retrofitted to existing apparatuses as a result of the use of suitable couplings. The different geometry of the bearing journals is compensated for by the coupling.

The coupling preferably has an axial compensator. By way of the latter, axial play, for example as a consequence of temperature changes, can be compensated for.

The coupling likewise preferably also has a radial compensator. This is advantageous, in particular, in retrofitting, as old bearing journals often no longer have exact roundness and have tolerances which are too large for it to be possible to run at relatively high speeds.

The coupling is advantageously of two-piece configuration, namely with a motor part and a journal part. The motor part can then preferably be standardized, with the result that the same motor part can always be used irrespectively of the journal geometry. As a result, the costs can be reduced, in particular in the case of retrofitting. Merely the journal part of the coupling has to be adapted to the journal geometry with regard to length and diameter, it being possible for it to be a small component here which is simple to handle and inexpensive to manufacture and procure.

What is known as a curved tooth coupling has proven to be a particularly suitable coupling. Satisfactory force transmission is possible with a coupling of this type.

The power output of the motors which can be used according to the invention can preferably be 20 kW or more. It is therefore also possible to run at very high roll speeds.

The invention also relates to a method for connecting a hollow-shaft drive motor to a roll of a paper machine or to a method for retrofitting or changing.

In the method according to the invention, it is possible in a simple manner for the motor to be connected to the roll frame via a motor fastener or a bracket.

The particular advantage of the invention consists in that the roll which is to be driven no longer has to be dismantled as a result, in order for it to be possible, for example, to machine the bearing journal to produce the roundness accuracy. The motor can therefore remain in the frame. As a result of this simplified attachment and mounting, it is also possible to replace the previously used cumbersome drives having articulated shafts with hollow-shaft motors which are placed on the roll journals. Here, the fastener is configured to be stable vibrationally.

In the case of retrofitting, it is appropriate to connect the hub of the motor to the bearing journal via a coupling. According to the invention, the coupling does not only have an axial compensator for compensating the axial play as a consequence of a temperature change, but also has a radial compensator. This is important, in particular, in retrofitting, as the old existing journals no longer guarantee exact roundness as a rule and have excessively large tolerances.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 shows a detail of a first embodiment of the apparatus according to the invention, partially in section; and

FIG. 2 shows a corresponding detail of a second embodiment of the apparatus according to the invention.

Corresponding reference characters indicate corresponding parts throughout the several views. The exemplifications set out herein illustrate one preferred embodiment of the invention, in one form, and such exemplifications are not to be construed as limiting the scope of the invention in any manner.

### DETAILED DESCRIPTION OF THE INVENTION

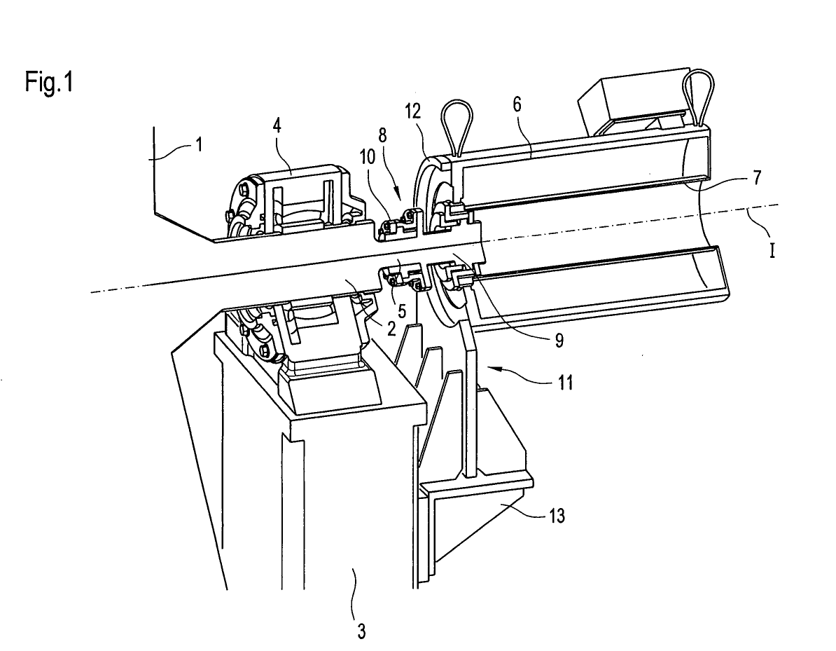

The apparatus which is shown in FIG. 1 includes a roll 1, in particular of a paper machine, which has a bearing journal 2 at one end, via which bearing journal 2 the roll 1 is mounted in a bearing 4 which is carried by a roll frame 3. Bearing journal 2 has an end section 5 of reduced diameter which protrudes beyond bearing 4 on the side which faces away from roll 1. A drive motor 6 for driving roll 1 rotationally in the manner which is described in the following text is plugged onto section 5. Roll 1 can be driven rotationally about its longitudinal axis I via motor 6.

Drive motor 6 has a hollow shaft 7, into which a coupling 8 with a motor part 9 is plugged. Motor part 9 of coupling 8 is connected in a manner which is known per se to a journal part 10 which is plugged onto section 5 of bearing journal 2 of roll 1. For this purpose, journal part 10 is adapted to the geometry, in particular the length and the diameter, of section 5 of bearing journal 2. Moreover, motor 6 is supported on roll frame 3 via a motor fastener 11. As a result, the weight of motor 6 is absorbed at least partially by roll frame 3. Bearing journal 2 of roll 1 is relieved accordingly. Motor fastener 11 includes a securing ring 12, to which motor 6 is fastened, and a supporting part 13 which is supported laterally on roll frame 3. As a result, the fastener is configured to be vibrationally stable, with the result that it is also possible to run at relatively high speeds.

Moreover, coupling 8 between bearing journal 2 and drive motor 6 has both an axial compensator and a radial compensator. The coupling can also preferably be configured as a curved tooth coupling. The power output of the motor can be 20 kW or more.

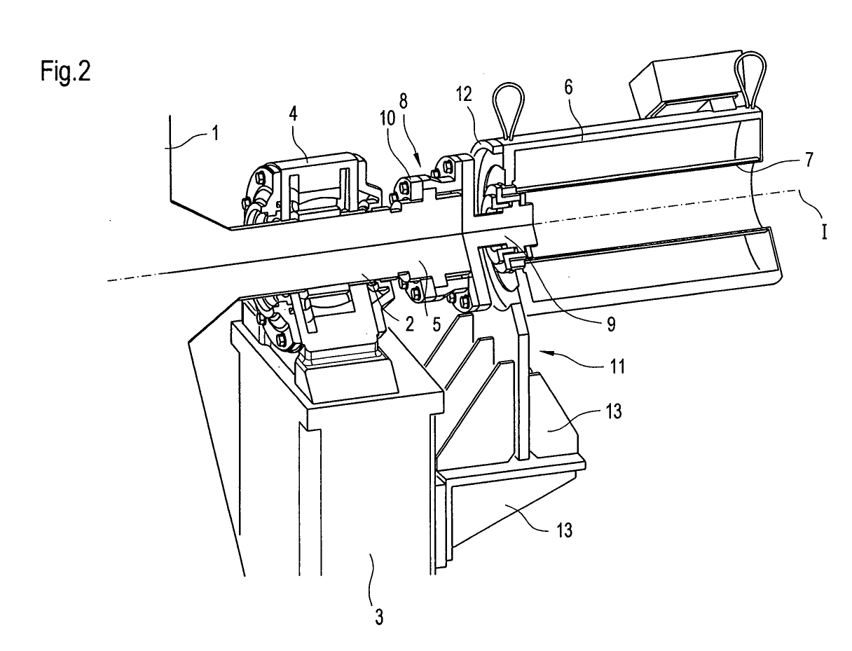

The embodiment which is shown in FIG. 2 corresponds substantially to the embodiment of FIG. 1. Section 5 of reduced diameter of bearing journal 2 has only a larger diameter here. Accordingly, journal part 10 of coupling 8 is configured with a larger internal diameter, while motor part 9 is unchanged. A standardized coupling part can therefore be used as motor part 9 of coupling 8, with the result that in each case only journal part 10 has to be exchanged in accordance with bearing journal 2 of roll 1. As a result, the costs of the apparatus can be reduced.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

### LIST OF REFERENCE NUMERALS

1 Roll
2 Bearing journal
3 Roll frame
4 Bearing
5 Section of 2
6 Plug-on motor
7 Hollow shaft
8 Coupling
9 Motor part of 8
10 Journal part of 8
11 Motor fastening means
12 Securing ring
13 Supporting part
I Rotational axis

What is claimed is:

1. An apparatus for one of manufacturing and treating a fiber material web, comprising: a roll having a bearing journal at one roll end, a frame for mounting the roll rotatably, and a hollow-shaft motor which is plugged onto the bearing journal of the roll the hollow-shaft motor being connected to the roll frame via a motor fastener.

2. The apparatus according to claim 1, wherein the motor fastener is configured to be stable vibrationally.

3. The apparatus according to claim 1, wherein said motor comprises a synchronous motor with a permanent magnet.

4. The apparatus according to claim 1, wherein the hollow-shaft motor includes a hollow shaft connected to the bearing journal of the roll via a coupling.

5. The apparatus according to claim 4, wherein the coupling has an axial compensator.

6. The apparatus according to claim 4, wherein the coupling has a radial compensator.

7. The apparatus according to claim 4, wherein the coupling is of two-piece configuration with a motor part and a journal part.

8. The apparatus according to claim 7, wherein the motor part is standardized.

9. The apparatus according to claim 4, wherein the coupling is configured as a curved tooth coupling.

10. The apparatus according to claim 1, wherein the hollow-shaft motor has a power output of more than 20 kW.

11. A method for one of connecting, changing and retrofitting a hollow-shaft drive motor to a roll of a machine for one of manufacturing and treating a fiber material web, the roll having bearing journals and being rotatably mounted in a frame, said method comprising the step of plugging a hollow-shaft motor onto a bearing journal of the roll, the hollow-shaft motor being connected to the roll frame via a motor fastener.

12. The method according to claim 11, wherein the motor fastener is configured to be stable vibrationally.

13. The method according to claim 11, wherein the hollow shaft motor comprises a synchronous motor with a permanent magnet.

14. The method according to claim 11, the hollow-shaft motor includes a hollow shaft connected to the bearing journal of the roll via a coupling.

15. The method according to claim 14, wherein the coupling has an axial compensator.

16. The method according to claim 14, wherein the coupling has a radial compensator.

17. The method according to claim 14, wherein the coupling has a motor part and a journal part.

18. The method according to claim 17, wherein the motor part is standardized.

19. The method according to claim 14, wherein the coupling is a curved tooth coupling.

20. The method according to claim 11, wherein the hollow-shaft motor is operated at an output power of at least 20 kW.
